(19) United States
(12) Patent Application Publication
(10) Pub. No.: US 2014/0202219 A1
(43) Pub. Date: Jul. 24, 2014

(54) Electrical Plug Lock

(71) Applicant: Richard John Stewart Bolland, Tauranga (NZ)

(72) Inventor: Richard John Stewart Bolland, Tauranga (NZ)

(73) Assignee: Carole Gaye Bolland, Tauranga (NZ)

(21) Appl. No.: 14/088,372

(22) Filed: Nov. 23, 2013

(30) Foreign Application Priority Data
Nov. 24, 2012 (NZ) 602601

(51) Int. Cl. E05B 15/00

(52) U.S. Cl. CPC E05B 15/00
USPC 70/32

(57) ABSTRACT

The invention is a locking device for use with any electrical equipment or appliance or device having a cord and attached electrical plug, it encapsulates the plug end and is lockable such that the electrical device is disabled and can no longer be plugged into a power source.

The invention includes a housing of two halves, hinged at one end, with the interior of the housing shaped and dimensioned to receive the electrical plug. The invention also includes a locking mechanism with two latches operable via a special key. The key has a shaft with two portions having differing widths and which are complementary to corresponding apertures in the latches.

The invention is useful for controlling the use of electrical devices, for example, gaming consoles and television.

### TECHNICAL FIELD

The invention is a locking device for use with any electrical equipment or appliance or device having a cord and attached electrical plug.

### BACKGROUND

A person may wish to disable a plug so the equipment cannot be operated or connected to a power source.

It is an object of the present invention to address the problem of locking and disabling a plug for an electrical device or at least provide the public with a useful choice.

Further aspects and advantages of the present invention will become apparent from the ensuing description which is given by way of example only.

### DISCLOSURE OF INVENTION

The plug lock encapsulates the plug end of an electrical cord that is connected to an electrical device so that device is disabled and can no longer be plugged into a power source.

The plug lock device consists of a housing of two halves, hinged at one end, with the inside space shaped for the electrical plug to fit into and a slot for the cord at the locking end.

The locking mechanism is at the opposite end to the hinges. This locking system incorporating double latches has a unique key.

The key consists of 2 tubes of a specific shape, such as, but not limited to, a hexagonal or other shape, each of slightly differing widths, joined together end to end to create the shaft of the key, that fit into the corresponding shaped tube in the lock.

Each of the two parts of the key, when fitted into the tube of the lock and turned, release the two separate spring loaded latches, unlocking the device.

The configuration of the shape and size of the two pieces that make up the shaft of the key, allows for each key to be unique.

### BRIEF DESCRIPTION OF DRAWINGS

Further aspects of the present invention will become apparent from the ensuing description which is given by way of example only and with reference to the accompanying drawings in which:

FIG. 1 is a perspective view of one embodiment of the invention;

FIG. 2 is a perspective view of the embodiment of FIG. 1 in an open condition;

FIG. 3a is a top view of the embodiment of FIG. 1;

FIG. 3b is a side cross-section view along lines E-E in FIG. 2b;

FIG. 3c is a side view of the embodiment of FIG. 1;

FIG. 3d is a front cross-section view along lines F-F in FIG. 2c;

FIG. 3e is a rear cross-section view along lines G-G in FIG. 2c;

FIG. 4 is a perspective view of an alternative embodiment of the invention;

FIG. 5a is a top view of the embodiment of FIG. 4;

FIG. 5b is a side cross-section view along lines B-B in FIG. 5a;

FIG. 6a is a side view of the key of the invention; and

FIG. 6b is a front end view of the key of FIG. 6a.

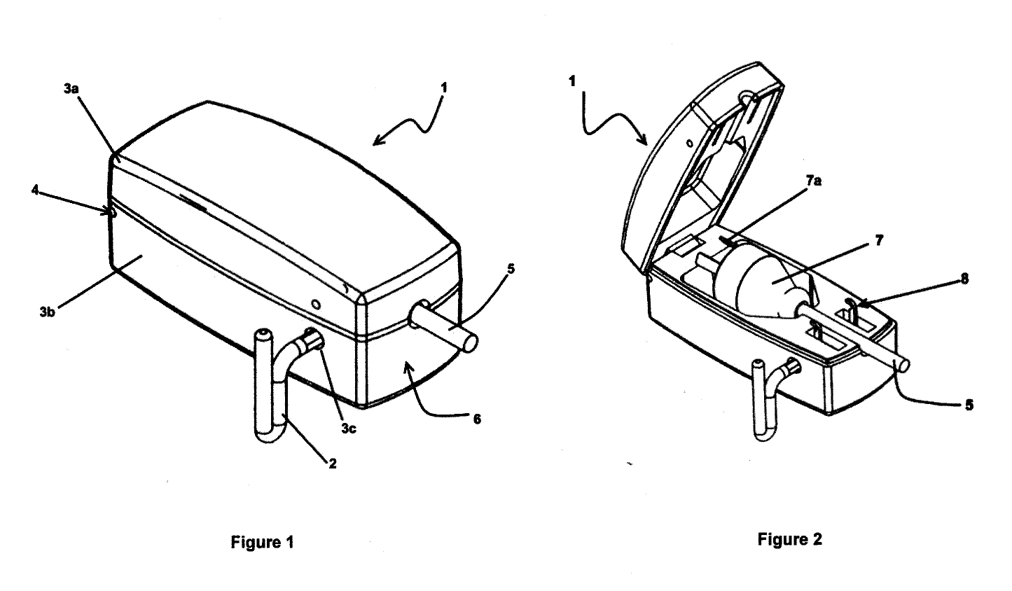

In FIG. 1, a first embodiment of the invention (generally Indicated by arrow 1) is shown in a dosed condition, with the locking key (2) inserted.

The invention (1) includes a housing of two halves (3a, 3b) hinged to each other at one end (4). An aperture (3c) is provided tor the locking key (2). The cord (5) of the electric plug (not shown in this view) can be seen extending from the other end (6). A latching mechanism locks the end (8) of the two halves together, trapping the plug within the invention.

Turning now to FIG. 2, the invention (1) is shown in an open condition. The plug (7) itself can be seen as can be the locking catch mechanism (8). This embodiment of the invention is for use with the enclosed plug type having prongs (7a) generally in line with the electrical cord (5).

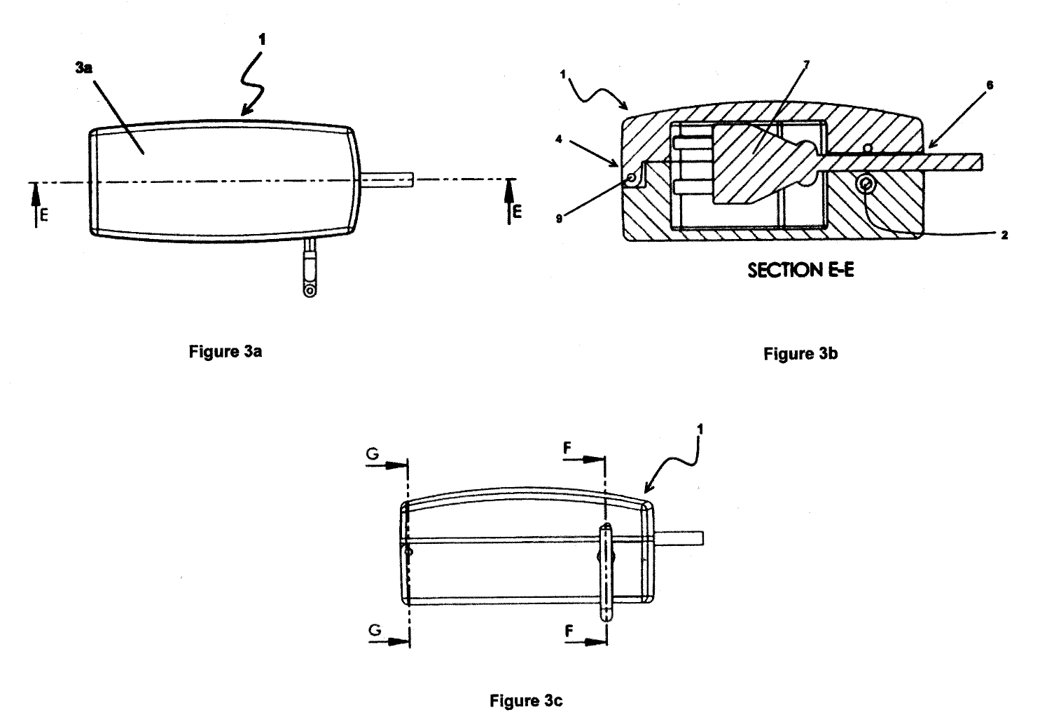

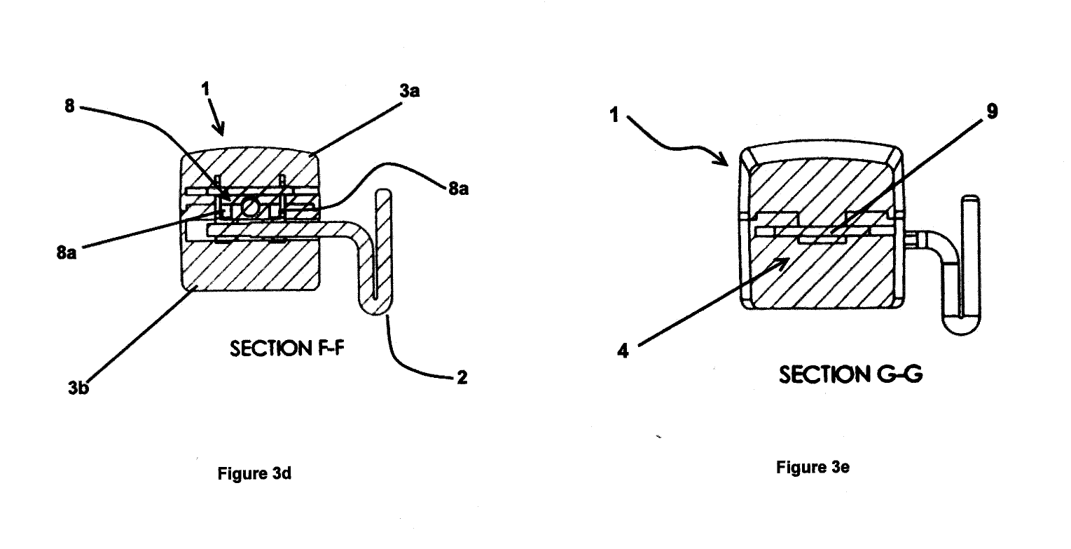

A top view of the invention (1) is shown in FIG. 3a. It should be appreciated that the curve and structure of the overall shape of the halves (3a; the half 3b is not visible in this view) comprising the invention is not limited to that shown in these drawings, but may be modified during manufacture for aesthetic, practicality, manufacturing or marketing purposes.

A cross-section view of the invention (1) along lines E-E in FIG. 3a is shown in FIG. 3b. This is a side on, cut away view of the inside of the invention showing the in-line type plug (7) with the hinge (9) at one end (4) and the locking catch mechanism (not visible) at the other end (8). The key (2), which passes through the locking mechanism, can be seen.

FIG. 3c is an exterior side view of the invention (1), while FIGS. 3d and 3c are front and rear cross-section views respectively of the invention.

In FIG. 3d, (a cross-section along lines F-F of FIG. 3c) the latches (8a) of the locking mechanism (8) are visible. The latches are rotatably mounted to the first half (3b) of the invention (1). The key (2) passes through suitably configured apertures (not shown) in the latches. The apertures are complementary to the cross-section of the key and thus when the key is rotated, this causes rotation of the latches which disengages them from the second half (3a). This unlocks the two halves, which can then be opened to access the plug (not visible).

FIG. 3e is of the hinge end (4) of the invention (1). The two halves (3a end 3b) interlock and a spindle passes through them to form the hinge (9).

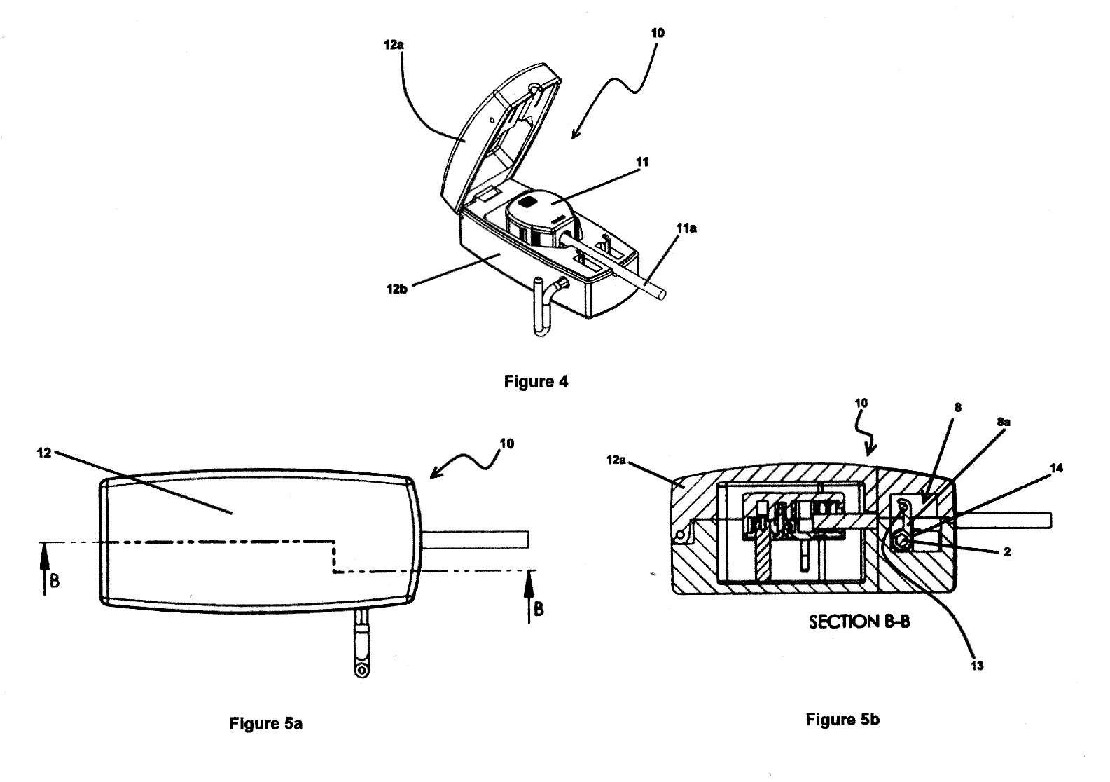

FIG. 4 is a perspective view of en alternative embodiment of the invention (10) for use with the type of plugs in which the plug (11) has prongs (not visible) which are substantially at a 90° degree angle to the electrical cord (11a).

Changes to the shape of the inside of the halves (12a, 12b) of the invention (10) can easily be made to accommodate any of the most common plug type configurations worldwide.

FIG. 5a is a top view of this embodiment of the invention (10), with FIG. 5b being a cross-section view along line B-B. The locking mechanism (3) is the same as the embodiment described in FIGS. 1 to 3.

The latches (8a) can be seen to be hocked and when rotated In the appropriate direction by the key (2), the hooks engage with a spindle (13) on the top half (12a) of the invention (10). The latches include torsion springs (14).

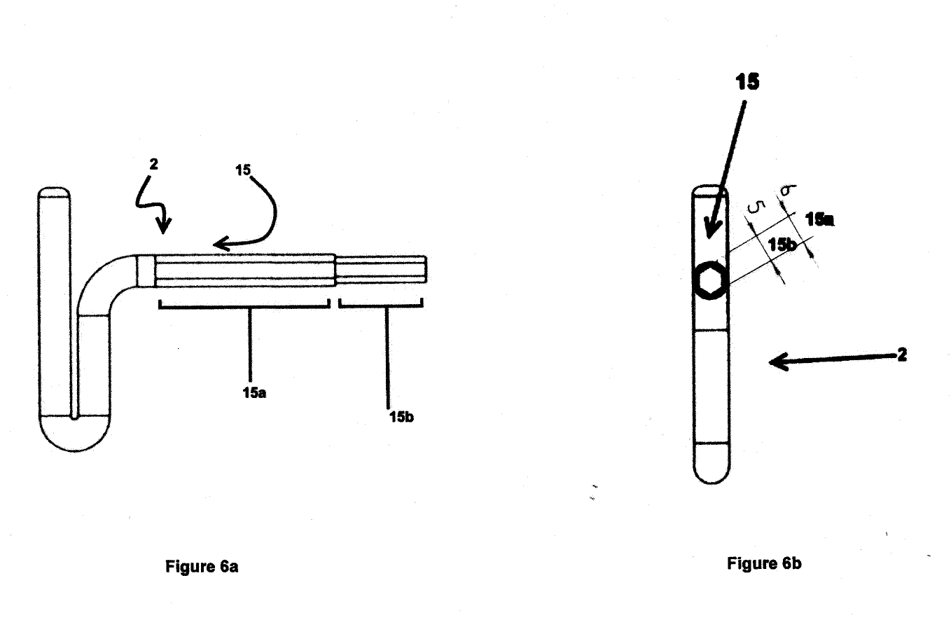

FIGS. 6a and 8b are of the locking key (2).

In FIG. 8a, a side view of the key (2), the shaft (15) of the key can be seen to be made up of two pieces (15a, 15b) of slightly different widths, joined together to make the shaft of the key.

The size and shape of each of the two pieces (15a, 15b) that make up the shaft (15) can be varied so that each key (2) can be unique.

In FIG. 8b, an end-on view of the key (2), the differing widths of the two pads (indicated by dimension lines 15a, 15b) that make up the shaft (15) of the key are shown.

It should be appreciated that the shape of the locking key (2) may be changed during manufacture for aesthetic, practicality, manufacturing or marketing purposes.

Aspects of the present invention have been described by way of example only and it should be appreciated that modifications and additions may be made thereto without departing from the scope thereof as defined in the appended claims.

What we claim is:

1. A locking device for an electrical plug, wherein the device includes:
a housing having a first half and a second half, each half hingedly connected to each other at one end, and wherein the housing has an inside space dimensioned and shaped to receive the electrical plug;
a locking mechanism, wherein the locking mechanism is at the opposite end to the hinged ends of the halves of the housing,
a key for the locking mechanism,
the locking device characterised in that
the locking mechanism includes at least a first and second latch, and wherein the key is configured with a shaft having two widths, wherein, a first portion of the shaft is operable on the first latch and a second portion of the shaft is operable on the second latch.

2. The locking device of claim 1 wherein one end of the latches are rotatably mounted to the first half of the housing.

3. The locking device of claim 2 wherein the opposing end of the latches are configured to engage with the second half of the housing.

4. The locking device of claim 1 wherein the latches are spring loaded.

5. The locking device of claim 1 wherein the first and second portions of the shaft of the key have a hexagonal cross-section.

6. The locking device of claim 1 wherein at least one of the first or second halves are configured with a slot for the cord of the electric plug.
